(19) United States
(12) Patent Application Publication
(10) Pub. No.: US 2019/0091776 A1
(43) Pub. Date: Mar. 28, 2019

(54) HOLE SAW ALIGNMENT GUIDE

(71) Applicant: Shane Shafer, Lewisburg, OH (US)

(72) Inventor: Shane Shafer, Lewisburg, OH (US)

(21) Appl. No.: 15/718,976

(22) Filed: Sep. 28, 2017

(51) Int. Cl. B23B 51/04; B23B 51/00

(52) U.S. Cl. CPC B23B 51/0426; B23B 51/0054

(57) ABSTRACT

A hole saw alignment guide for enlarging a hole in an object to provide a larger diameter hole in the object. The hole saw guide includes a first cylindrical part having a first end adapted to the size of, and adapted to be inserted into, the hole that is to be enlarged. The hole saw guide also has a second cylindrical part integral with the second end of the first cylindrical part. The hole saw guide is adapted to receive over the outer surface of the first cylindrical part a toothed end of a hole saw sized to provide the larger diameter hole. The second cylindrical part is adapted to extend into an arbor of the hole saw and to be secured to the arbor for rotation with the hole saw. The arbor of the hole saw is adapted to be received in a drill chuck.

### BACKGROUND OF THE INVENTION

The present application relates to a hole saw alignment guide for enlarging a hole in an object to provide a larger diameter hole in the object.

Hole saws typically have a drill bit in order to drill into an object and allow the hole saw to follow and create an initial hole in the object. However, if this hole, or any other hole, such as a pre-punched hole in an electrical box, needs to be enlarged, there is no reliable way to center the hole saw over the existing hole.

It is therefore an object of the present invention to provide a device for aligning, centering and guiding a hole saw in order to be able to enlarge an existing hole.

### BRIEF DESCRIPTION OF THE DRAWINGS

This object and other objects and advantages of the present invention, will appear more clearly from the following specification in conjunction with the accompanying schematic drawings, in which:

FIG. 1 shows how the hole saw alignment guide of the present application is used in conjunction with a hole saw and a drill;

FIG. 2 shows how an existing hole in an object is to be enlarged using the hole saw alignment guide of the present application; and

FIG. 3 shows a hole saw placed over the hole saw alignment guide.

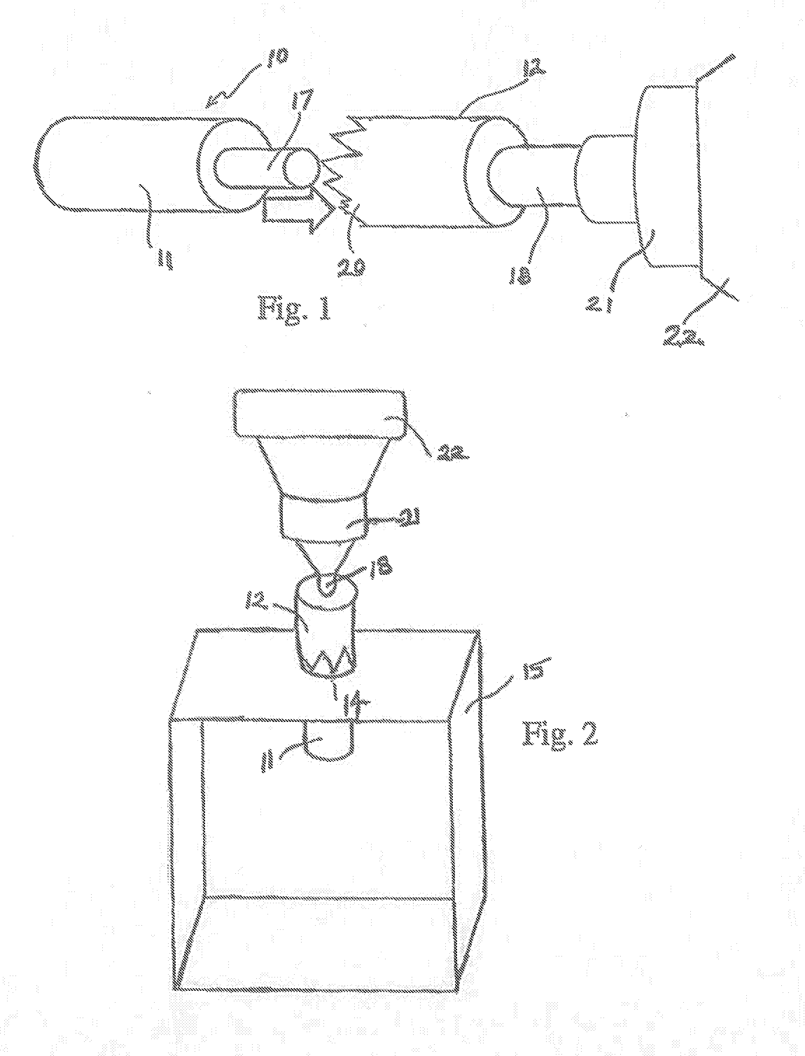

### SUMMARY OF THE INVENTION

The hole saw alignment guide of the present application for enlarging a hole in an object comprises a first cylindrical part and a second cylindrical part. The first cylindrical part has a first end adapted to the size of, and adapted to be inserted into, the hole that is to be enlarged. The second cylindrical part is integral with, and extends coaxially from, the second end of the first cylindrical part. The hole saw alignment guide is adapted to receive over part of the outer surface of the first cylindrical part a toothed end of a hole saw that is sized to provide the larger diameter hole in the object, wherein the toothed end of the hole saw will be spaced from, and will expose, the first end of the first cylindrical part. The second cylindrical part of the hole saw alignment guide is adapted to extend into an arbor of the hole saw opposite the toothed end of the hole saw. The second cylindrical part is adapted to be secured to the arbor of the hole saw for rotation therewith, and the arbor of the hole saw is adapted to be received in a drill chuck.

The diameter of the second cylindrical part of the hole saw alignment guide can be less than the diameter of the first cylindrical part.

### DETAILED DESCRIPTION OF THE DRAWINGS AND A PREFERRED EMBODIMENT

The hole saw alignment guide of the present application is designated generally by the reference numeral 10, and is used to guide a hole saw 12 for enlarging an existing hole in an object.

In particular, as shown in FIG. 2, the hole saw alignment guide 10 is provided with a first cylindrical part 11 that is snuggly insertable in to or through a hole 14 that exists in an object 15, by way of example only, metal or plastic electrical boxes, electrical load centers, panel boxes, service boxes, electrical disconnects, tubs, cable trays, gutters, troughs, pvc boxes, or the like, such as produced by Panduit. The diameter of the first cylindrical part 11 is matched to the diameter of the hole 14. The purpose of the hole saw alignment guide 10 is to provide a stable way to align, center, and guide the hole saw 12 over the hole 14 in order to be able to enlarge the hole 14.

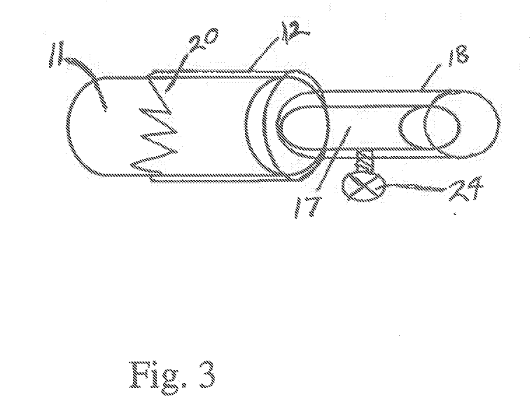

As can be seen in the drawings, the hole saw alignment guide 10 is inserted into the hole saw 12, which has a larger diameter than does the hole saw guide 10, and in particular has the diameter of the new, enlarged hole that is to be made in the object 15 and has the same center line as does the hole 14. To secure the hole saw alignment guide 10 in the hole saw 12, the hole saw guide is provided with a second cylindrical part 17 or stem that extends from an end of the first cylindrical part 11 of the hole saw guide 10. The hole saw 12 is provided with a hollow arbor 18 at an end of the hole saw 12 that is opposite its toothed end 20. The arbor 18 is intended to be held in the chuck 21 of a drill 22 such that the hole saw 12 can be rotated by the drill 22. To effect the securement of the second cylindrical part 17 of the hole saw guide 10 in the hole saw 12, the second cylindrical part 17 is introduced into the arbor 18 of the hole saw 12, and, as shown in detail in FIG. 3, is secured in the hole saw 12 by means of a set screw 24 or the like such that the hole saw alignment guide 10 can rotate along with the hole saw 12. For this purpose, the set screw 24 is threadedly held in the arbor 18 and can be screwed tightly against the second cylindrical part 17 of the hole saw guide 10.

In operation, the hole saw alignment guide 10 of the present application is used to enlarge a hole 14 that has been punched out or otherwise exists in an object 15 (see FIG. 2). For this purpose, the hole saw guide 10 is inserted into the hole saw 12, with the second cylindrical part 17 of the hole saw guide 10 being introduced first. The second cylindrical part 17 is inserted far enough into the hole saw 12 that it enters the arbor 18, whereupon the second cylindrical part is secured in the arbor 18, for example by means of the set screw 24 (see FIG. 3). The length of the first cylindrical part 11 of the hole saw guide 10 is such that when the hole saw guide is introduced into the hole saw guide 12, the toothed end 20 of the hole saw 12 partially overlaps the first cylindrical part 11, but leaves part of it free. This free end of the first cylindrical part 11 is then inserted into the existing hole 14. The arbor 18 of the hole saw 12 has been inserted into, and is held by, the chuck 21 of the drill 22, so that when the drill is turned on, the hole saw 12 will rotate and the toothed end 20 of the hole saw 12 will enlarge the hole 14 when the toothed end 20 is pressed against the object 15 by cutting away material around the existing hole 14, thereby enlarging it.

The present invention is, of course, in no way restricted to the specific disclosure of the specification and drawings, but also encompasses any modifications within the scope of the appended claims.

What I claim is:

1. A hole saw alignment guide for enlarging a hole in an object to provide a larger diameter hole in the object, comprising:
a first cylindrical part (11) having a first end that is adapted to the size of, and is adapted to be inserted into, the hole that is to be enlarged; and
a second cylindrical part (17) that is integral with, and extends coaxially from, a second end of said first cylindrical part (11), wherein said hole saw alignment guide (10) is adapted to receive over part of an outer surface of said first cylindrical part (11) a toothed end (20) of a hole saw (12) sized to provide the larger diameter hole in the object, wherein the toothed end (20) of the hole saw (12) will be spaced from, and will expose, said first end of said first cylindrical part (11), further wherein said second cylindrical part (17) is adapted to extend into an arbor (18) of the hole saw (12) opposite the toothed end (20) of the hole saw, further wherein said second cylindrical part (17) is adapted to be secured to the arbor (18) of the hole saw (12) for rotation therewith, and wherein the arbor (18) of the hole saw (12) is adapted to be at least partially received in a chuck of a drill.

2. A hole saw alignment guide according to claim 1, wherein said second cylindrical part (17) is adapted to be secured to the arbor (18) of the hole saw (12) via a set screw (24).

3. A hole saw alignment guide according to claim 2, wherein the arbor (18) of the hole saw (12) is hollow for receiving said second cylindrical part (17) of said hole saw alignment guide.

4. A hole saw alignment guide according to claim 3, wherein said second cylindrical part (17) of said hole saw alignment guide (10) has a diameter that is less than the diameter of said first cylindrical part (11) of said hole saw alignment guide.

5. A hole saw alignment guide according to claim 4, wherein said hole saw alignment guide (10) is a single component.
